(19) United States
(12) Patent Application Publication
(10) Pub. No.: US 2012/0181326 A1
(43) Pub. Date: Jul. 19, 2012

(54) DIE-CUTTING BLADE AND CASE-FORMING DIE-CUT BLANK

(76) Inventor: Takayuki Takeuchi, Toyonaka (JP)

(21) Appl. No.: 13/497,074

(22) PCT Filed: Oct. 29, 2010
(86) PCT No.: PCT/JP10/69327

§ 371 Date: Apr. 4, 2012

(30) Foreign Application Priority Data
Jun. 30, 2010 (JP) 2010-149022

(51) Int. Cl. B65D 5/42; B26F 1/44

(52) U.S. Cl. 229/100; 83/651

(57) ABSTRACT

A die-cutting blade can form smooth die-cut lines in case-forming blanks which are less likely to injure hands, even if touched by the hands. A strip-plate-shaped steel blade plate has a pair of chamfers formed on opposite side surfaces of the blade plate, respectively, so as to extend from one side edge of the blade plate at substantially equal inclination angles. The chamfers define a cutting edge along the one side edge. The cutting edge has a composite wave pattern formed from a small wave pattern bent to have a wave shape within the range of the thickness of the blade plate, and a large wave pattern formed by a large undulation in the small wavy edge toward opposite side surfaces of the blade plate over its entire length within the range of the thickness of the blade plate, in order to provide smooth die-cut lines.

### TECHNICAL FIELD

The present invention relates to die-cutting blades for use in die cutting for sheets, such as corrugated paperboard sheets and cardboards, into predetermined shapes, and also relates to case-forming die-cut blanks.

### BACKGROUND ART

Multi-packs collectively packing a plurality of to-be-packed objects, such as cans and bottles filled with drinking water such as beers, are usually packed with a wrap around case K illustrated in FIG. 10. Further, the wrap around case K is brought into an assembled state, by performing folding and adhering on a blank, which is formed by performing-die cutting and scoring on a corrugated paperboard sheet.

FIG. 9 illustrates a blank B as a material to form a wrap around case K. This blank B includes two pairs of side panels 1 and 2 having different widthwise sizes which are alternately and continuously provided in a single direction with vertical fold lines “a” interposed therebetween, a joint tab panel 3 provided continuously on a side edge of a smaller-width side panel 1 positioned in one side with a vertical fold line “a” interposed therebetween, inner flaps 4 provided continuously on the respective opposite ends of the pair of smaller-width side panels 1 with lateral fold lines “b” interposed therebetween, and outer flaps 5 provided continuously on the respective opposite ends of the remaining pair of larger-width side panels 2 with lateral fold lines “b” interposed therebetween.

In assembling the wrap around case K using the blank B, one pair of side panels 1 and the remaining pair of side panels 2 are formed into a rectangular tubular shape as illustrated in FIG. 10 by folding them along the vertical fold lines “a”, then the joint tab panel 3 and a side panel 2 are adhered to each other at their portions to be overlapped with each other to form an angular tubular body 6. Thereafter, the inner flaps 4 and the outer flaps 5 are folded inwardly, and the inner flaps 4 and the outer flaps 5 are adhered to each other at their portions to be overlapped with each other to close the body 6 at its opposite-end openings. In the first step for closing a single opening of the body 6, a plurality of multi-packs P are housed inside the body 6. Reference numeral “7” denotes an adhesive agent for adhering the inner flaps 4 and the outer flaps 5 to each other at their portions to be overlapped with each other.

On the other hand, when a wrap around case K as described above is opened at home, in order to take out a necessary number of packed objects A such as beer cans therefrom and to store the remainder without increasing its volume, in many cases, the wrap around case K is opened at its end surface formed by the upper outer flaps 5 and the upper inner flaps 4 overlapped with each other, at a state where it is placed vertically. In this case, the outer flaps 5 in the outer side are stripped from the inner flaps 4 in the inner side, by putting the hands on the end edges of the outer flaps 5.

In this case, such a blank B is formed as follows. That is, as illustrated in FIG. 11A, a cutting die 22 is provided on a lower surface of an upper die 21 which can ascend and descend with respect to a cutting plate 20 made of stainless steel. Further, by descending the cutting die 22, as illustrated in FIG. 11B, die cutting is performed on a corrugated paperboard sheet S supported on the cutting plate 20, with a die-cutting blade 23 mounted in the lower surface of the cutting die 22. For performing such die cutting, a die-cutting blade with a straight-shaped cutting edge as described in Patent Document 1 or a die-cutting blade with a wavy cutting edge as described in Patent Document 2 has been generally employed.

### PRIOR ART DOCUMENTS

### Patent Documents

Patent Document 1: Japanese Patent Laid-open Publication No. 2000-127258

Patent Document 2: Japanese Patent Laid-open Publication No. 2001-191297

### SUMMARY OF THE INVENTION

### Problems to be Solved by the Invention

However, the die-cutting blade described in Patent Document 1 has a cutting edge having a straight shape and, therefore, having higher acuteness. Further, the die-cutting blade described in Patent Document 2 is made to have a single wave shape with a larger radius of curvature since its edge portion has a wave shape, and its the cutting edge has relatively-higher acuteness. Accordingly, a blank B formed by die cutting therewith also has higher acuteness at its outer peripheral cut edges and, when the outer flaps 5 are stripped from the inner flaps 4 to open the wrap around case K by putting the hands on the end edges 5a of the outer flaps 5, the hands may be injured by touching the end edges 5a. Other end edges can also injure the hands, by being touched by the hands.

To cope therewith, in order to prevent injuries of the hands, Japanese Patent Laid-open Publication No. 2008-44664 proposes a corrugated paperboard box, wherein a reference line is defined in parallel with an end edge of an outer flap, there are provided, in a lattice shape, a plurality of fold lines orthogonal to the reference line, and a plurality of fold lines intersecting therewith and, further, there is formed a crushed portion in the corrugated paperboard having rigidity from an end edge thereof to a position spaced apart therefrom, in order to increase the softness of the corrugated paperboard box.

However, the aforementioned corrugated paperboard box includes the crushed portion spreading over a wide range and, therefore, may exhibit poor strength when being closed. Further, in order to form the fold lines therein, it is necessary to perform processing for forming slots for mounting a lattice-shaped pushing piece in the cutting die 22 illustrated in FIG. 11 and, also, it is necessary to perform processing for forming fitting slots in the cutting plate 20 at positions to face the lattice-shaped pushing piece, which induces the problems of an increase in the cost and a need for higher positioning accuracy in mounting the cutting plate 20 and the cutting die 22 in the die cutting machine.

It is an object of the present invention to provide a die-cutting blade capable of forming, in sheets such as corrugated paperboard sheets or cardboards, smooth die-cut lines which are less likely to injure hands even when being touched by the hands and, further, to provide a die-cut blank made of a sheet, such as a corrugated paperboard sheet or cardboard, which enables formation of a box that is less likely to induce injuries when its outer peripheral die-cut lines are touched.

### Means for Solving the Problems

In order to solve the aforementioned problems, the present invention provides a sheet die-cutting blade comprising a strip-plate-shaped blade plate having a predetermined length and made of a steel plate, the blade plate being provided with a pair of chamfers formed on the respective side surfaces of the blade plate so as to extend from one side edge of the blade plate at substantially the same inclination angle, the chamfers defining a cutting edge along the one side edge of the blade plate, wherein the cutting edge has a composite wave pattern comprising a large wave pattern and a small wave pattern, the large wave pattern comprising a plurality of longitudinally continuous large waves, the small wave pattern comprising a plurality of longitudinally continuous small waves, wherein each of the large waves contains a plurality of the small waves, and wherein the small wave pattern is entirely located within the thickness of the blade plate.

In this case, the small wave pattern and the large wave pattern may be either wave patterns having respective sine-curve shapes with fixed pitches and fixed wave widths or wave patterns having respective curved shapes with irregular pitches and irregular widths.

The large wave pattern may be located within the thickness of the blade plate, and only the chamfers have a wave pattern may have crests and troughs corresponding to the large wave pattern. Alternatively, the entire opposite side surfaces of the blade plate may have a wave pattern having crests and troughs corresponding to the large wave pattern.

In general, die-cutting blades for use in die cutting for corrugated paperboard sheets and cardboards are formed from blade plates made of strip-shaped steel plates having thicknesses in the range of 0.45 mm to 1.8 mm. Therefore, in forming a composite wave pattern comprising a large wave pattern and a small wave pattern which have respective sine-curve shapes, it is preferable that the respective pitches, the respective wave widths, and the respective radii of curvature in the large wave pattern and the small wave pattern fall within the following ranges, in view of fabrication of the respective wave patterns and the prevention of injuries due to sheet cut lines formed by the composite wave pattern.

In the large wave pattern, the pitch P₂, the wave width W₂, and the radius of curvature R of the waves preferably fall within the ranges of: P₂=2.0 mm to 10.0 mm, W₂=0.1 mm to 1.2 mm, and R₂=2.0 mm to 6.0 mm.

The pitch P₂, the wave width W₂, and the radius of curvature R of the waves in the large wave pattern are properly determined according to the plate thickness (the thickness) of the blade plate. More specifically, when the plate thickness of the blade plate is about 0.9 mm, these values preferably fall within the ranges of: P₂=2.0 mm to 5.0 mm, W₂=0.1 mm to 0.6 mm, and R=3.0 mm to 5.0 mm. Further, when the plate thickness of the blade plate is about 1.07 mm, these values preferably fall within ranges of: P₂=3.0 mm to 6.0 mm, W₂=0.2 mm to 0.8 mm, and R=3.0 mm to 5.0 mm. In this case, the term “about” means the range of ±0.05 mm.

In the small wave pattern, the pitch P₁, the wave width W₁, and the radius of curvature r of the waves preferably fall within the ranges of: P₁=0.2 mm to 2.0 mm, W₁=0.02 mm to 0.5 mm, and r=0.2 mm to 1.5 mm. The pitch P₁, the wave width W₁, and the radius of curvature r of the waves in the small wave pattern are properly determined according to the pitch P₄, the wave width W₂, and the radius of curvature R of the waves in the large wave pattern such that a plurality of continuous ones of the waves in the small wave pattern are formed per single wave in the large wave pattern. More specifically, when the plate thickness of the blade plate is about 0.9 mm, these values preferably fall within the ranges of: P₁=0.6 mm to 1.2 mm, W₁=0.05 mm to 0.2 mm, and r=0.3 mm to 0.6 mm. Further, when the plate thickness of the blade plate is about 1.07 mm, these values preferably fall within the ranges of: P₁=0.8 mm to 1.4 mm, W₁=0.08 mm to 0.3 mm, and r=0.3 mm to 1.0 mm.

In order to solve the aforementioned problems, as a case-forming die-cut blank according to the present invention, there is provided a case-forming die-cut blank including two pairs of opposing side panels to form a rectangular tubular-shaped body, inner flaps provided continuously on respective end edges of one pair of side panels, and outer flaps provided continuously on respective end edges of the remaining pair of side panels, such that the outer flaps are to be adhered to the inner flaps to close an opening of the body, wherein the blank has outer peripheral edges, of which at least outer peripheral edges of the outer flaps are formed from a cut line formed by die cutting with the aforementioned sheet die-cutting blade according to the present invention, and the cut line is formed from a composite wavy line formed from a small wavy curve having an undulation with a small pitch which forms alternate and successive crests and troughs, and a large wavy curve having an undulation forming alternate and successive crests and troughs with a large pitch than that of the small wavy edge such that the large wavy curve is provided with respect to the small wavy curve as a reference, and such that a plurality of crests in the small wavy curve are formed per single crest in the large wavy curve.

In this case, assuming that the pitch of the crests is P₃, the height of the crests is H₃, and the radius of curvature of the waves is r₃ in the small wavy curve, and the pitch of the crests is P₄, the height of the crests is H₄, and the radius of curvature of the waves is R₄ in the large wavy curve, in view of preventing injuries of the hands, it is preferable that these values fall within the ranges of: P₃=0.2 mm to 2.0 mm, H₃=0.02 mm to 0.5 mm, r₃=0.2 mm to 1.5 mm, and P₄=2.0 mm to 10.0 mm, H₄=0.1 mm to 1.2 mm, and R₄=2.0 mm to 6.0 mm.

### Effects of the Invention

As described above, according to the present invention, the cutting edge in the die-cutting blade for use in die cutting for sheets such as corrugated paperboard sheets and cardboards is formed to be the composite wave pattern formed from the small wave pattern having a small undulation toward the opposite side surfaces of the blade plate within the range of the thickness of the blade plate, and the large wave pattern formed by undulating the small wave pattern toward the opposite side surfaces of the blade plate in the longitudinal direction such that the undulation in the large wave pattern is larger than that in the small wave pattern, and such that a plurality of the waves in the small wave pattern are formed per single wave in the large wave pattern. Accordingly, as a result of die cutting on a sheet, the cut line formed by the die cutting has a wave shape having fine waves forming crests and troughs. Consequently, it is possible to provide smooth die-cut lines which softly come into contact with the hands and are less likely to injure the hands. Therefore, by forming at least the outer peripheral edges of the outer flaps from cut lines formed by die cutting with the aforementioned sheet die-cutting blade according to the present invention, it is possible to provide a significantly larger effect in preventing injuries of the hands.

Further, since the cutting edge is formed to be a composite wave pattern formed from the small wave pattern and the large wave pattern, in die cutting on corrugated paperboard sheets, it is possible to suppress formation of stripe-type elongated paper dusts, from the corrugated medium paper which is formed therein in corrugated shapes. Further, since the large wavy edge is made to have an undulation within the range of the thickness of the blade plate, the blade plate is maintained at a straight-shaped strip-plate state at its portion other than the edge portion. Accordingly, for mounting the die-cutting blade in a cutting die, it is necessary only to form a straight-shaped mounting slot in the cutting die, thereby making it easier to perform the processing for forming the slot. Further, this makes it easier to mount the die-cutting blade in the cutting die.

Furthermore, with the large wave pattern formed by shaping the entire opposite side surfaces of the blade plate into a wave shape, it is possible to fabricate the large wave pattern more easily than in case of forming the large wave pattern by shaping only a portion of the blade plate into a wave shape. The blade plate also has a wave shape at its portion to be mounted in the cutting die, which enables securely mounting the blade plate in the cutting die.

### BRIEF DESCRIPTION OF THE DRAWINGS

FIG. 1A is a perspective view illustrating an embodiment of a sheet die-cutting blade according to the present invention, and FIG. 1B is a perspective view illustrating a portion of FIG. 1A in an enlarged manner.

FIGS. 2A, 2C, and 2E are plan views illustrating states of formation of the sheet die-cutting blade illustrated in FIG. 1 in a stepwise manner, and FIGS. 2B, 2D, and 2F are lateral cross-sectional views corresponding to FIGS. 2A, 2C, and 2E, respectively.

FIG. 3 is a plan view illustrating another embodiment of a sheet die-cutting blade according to the present invention.

FIG. 4 is a lateral cross-sectional view illustrating another example of a blade plate.

FIG. 5 is a plan view illustrating a portion of a sheet having been subjected to die cutting with the sheet die-cutting blade illustrated in FIG. 1.

FIG. 6 is a perspective view of a die-cutting blade to be mounted in a rotary die-cutting machine.

FIG. 7 is a perspective view illustrating another embodiment of a sheet die-cutting blade according to the present invention.

FIGS. 8A and 8B are plan views illustrating states of formation of the sheet die-cutting blade illustrated in FIG. 7 in a stepwise manner.

FIG. 9 is a front view illustrating a blank to form a wrap around case.

FIG. 10 is a perspective view illustrating a conventional wrap around case in an opened state.

FIG. 11A is a longitudinal cross-sectional view illustrating a die cutting machine, and FIG. 11B is a longitudinal cross-sectional view illustrating a state of die cutting on a sheet.

### EMBODIMENT FOR CARRYING OUT THE INVENTION

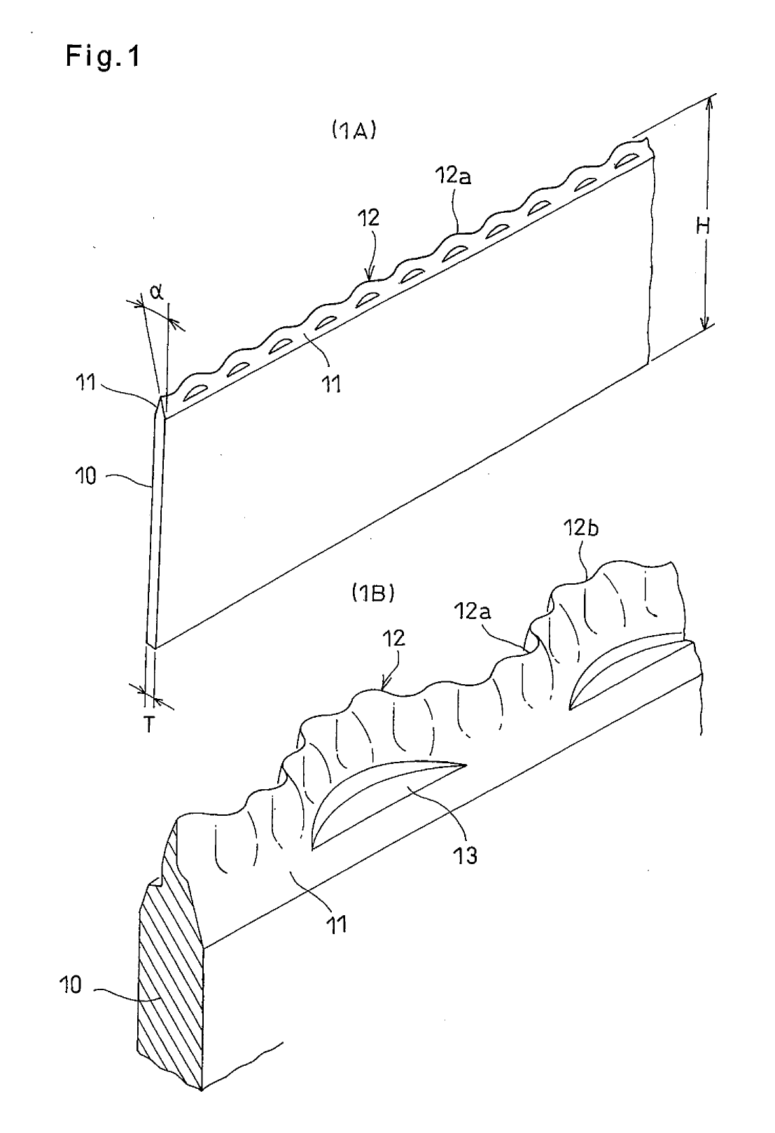

Hereinafter, an embodiment of the present invention will be described with reference to the drawings. As illustrated in FIGS. 1A and 1B, a blade plate 10 is formed from a strip-plate-shaped steel plate having a predetermined length, wherein H is about 23.5 mm and T falls within the range of 0.45 mm to 1.8 mm, assuming that H is the height thereof and T is the thickness (the plate thickness) thereof.

The blade plate 10 is provided with a pair of chamfers 11 on its respective opposite side surfaces so as to extend from one side edge of the blade plate, i.e. one of its upper and lower side edges at substantially the same inclination angle a in opposite directions. The chamfers 11 define a cutting edge 12 along the one side edge.

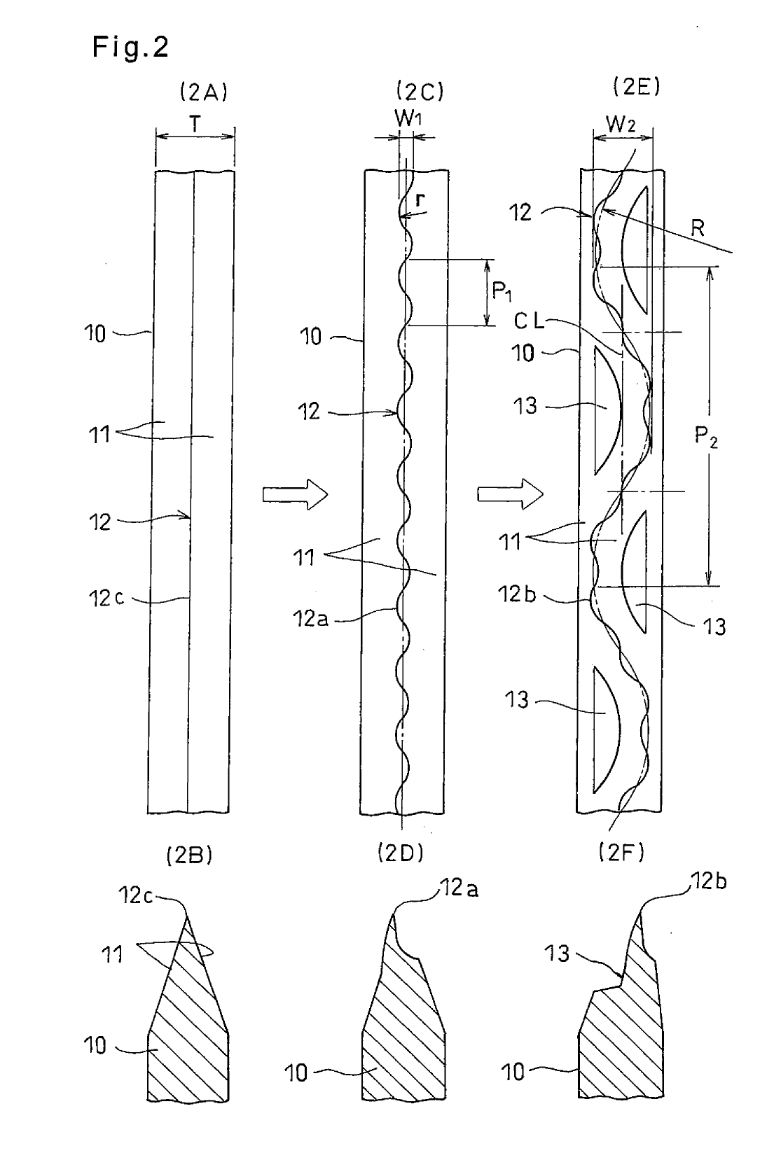

As illustrated in FIGS. 2C and 2E, the cutting edge 12 has a composite wave pattern comprising a small wave pattern 12a and a large wave pattern 12b. In other words, the cutting edge 12 is waved in the small wave pattern 12a, and the small wave pattern 12a is further waved in the large wave pattern 12b. The small wave pattern 12a has longitudinally and alternately arranged first and second crests which face in opposite directions to each other. The large wave pattern 12b has longitudinally and alternately arranged third and fourth crests which face in opposite directions to each other. The cutting edge is located within the thickness of the blade plate 10. Only the chamfers 11 are undulated in a composite wave pattern having vertical crests and troughs extending from the respective first to fourth crests of the small and large wave patterns 12a and 12b.

Further, as illustrated in FIGS. 2C and 2E, it is preferable that the wave width W₁ between the adjacent first and second crests of the small wave pattern 12a is made smaller than the wave width W₂ between the adjacent third and fourth crests of the large wave pattern 12b. But instead, the wave width W₁ may be larger than the wave width W₂. Also, it is possible to make the wave width W₁ and the wave width W₂ equal to each other.

The cutting edge 12 having the aforementioned structure can be formed through respective processes constituted by first to third processes as follows.

First process: as illustrated in FIGS. 2A and 2B, in the first process, the chamfers 11 are formed on the respective opposite side surfaces of the blade plate so as to extend obliquely in opposite directions from one side edge of the blade plate, i.e. one of its upper and lower side edges. By the chamfers 11, straight cutting edge 12c is defined which extends longitudinally substantially along the widthwise centerline of the blade plate 10.

Second process: as illustrated in FIGS. 2C and 2D, the straight cutting edge 12c formed through the first process is formed into a sine-curve shape with a small radius of curvature r, through press forming using a wave-shape die plate, to form the small wave pattern 12a having the wave width W₁ between the adjacent first and second crests in alternately opposite directions in such a way as to form an undulation toward the opposite side surfaces of the blade plate 10, in the longitudinal direction, within the range of the thickness T of the blade plate 10.

Third process: as illustrated in FIGS. 2E and 2F, the small wave pattern 12a formed through the second process is formed in its entirety into a sine-curve shape with a large radius of curvature R, through press forming using a wave-shape die plate, to form the large wave pattern 12b having the wave width W₂ between the third and fourth crests in alternately opposite directions in such a way as to form an undulation toward the opposite side surfaces of the blade plate 10 in the longitudinal direction within the range of the thickness T of the blade plate 10, by using the entire small wave pattern 12a as a reference. Thus, the composite wave pattern is formed. In the figures, numeral 13 denotes traces of the pressing with the wave-shape die plate.

In the small wave pattern 12a resulted from the shaping in the second process, if the pitch P₁ of its waves is excessively smaller than necessary, in view of the relationship with the wave width W₁ between the adjacent first and second crests in alternately opposite directions, this will increase the difficulty of shaping for the small wave pattern 12a. On the other hand, if the pitch P₁ is excessively larger than necessary, this will increase the acuteness of cut lines resulted from die cutting on sheets. Accordingly, it is preferable that the pitch P₁, the wave width W₁, and the radius of curvature r of the respective waves fall within the ranges of: P₁=0.2 mm to 2.0 mm, W₁=0.02 mm to 0.5 mm, r=0.2 mm to 1.5 mm.

On the other hand, in the large wave pattern 12b resulted from the shaping in the third process, if the pitch P₂ of its waves is excessively larger than necessary, the small wave pattern 12a comes closer to a straight shape in a state where it has been brought into the composite wave pattern, which makes it impossible to provide smooth cut lines which can softly come into contact with the hands. Further, if it is excessively smaller than necessary, the small wave pattern 12a may be broken when being shaped into the composite wave pattern. Accordingly, it is preferable that the pitch P₂, the wave width W₂, and the radius of curvature R of the waves fall within the ranges of: P₂=2.0 mm to 10.0 mm, W₂=0.1 mm to 1.2 mm, R=2.0 mm to 6.0 mm.

Further, the pitch P₁ in the small wave pattern 12a is set to be smaller than the pitch P₂ in the large wave pattern 12b such that each wave of the large wave pattern 12b contains a plurality of longitudinally continuous ones of the waves of the small wave pattern 12a.

The pitch P₂, the wave width W₂, and the radius R of curvature of the waves of the large wave pattern 12b are properly determined according to the plate thickness (the thickness) T of the blade plate 10. Table 1 illustrates specific examples thereof.

The pitch P₁, the wave width W₁, and the radius r of curvature of the waves in the small wave pattern 12a are properly determined according to the thickness T of the blade plate 10, and according to the pitch P₂, the wave width W₂, and the radius R of curvature of the large wave pattern 12b. Table 1 illustrates specific examples thereof.

TABLE 1

| Type of Blade Plate | | | | | | | | |
|---|---|---|---|---|---|---|---|---|
| (Thickness of Blade Plate) | | 0.45 mm | 0.7 mm | 0.9 mm | 1.07 mm | 1.2 mm | 1.4 mm | 1.8 mm |
| Small Wavy | Pitch P₁ (mm) | 0.2-0.6 | 0.4-0.8 | 0.6-1.2 | 0.8-1.4 | 1.0-1.6 | 1.2-1.8 | 1.2-2.0 |
| Edge | Wave Width W₁ | 0.02-0.08 | 0.04-0.1 | 0.05-0.2 | 0.08-0.3 | 0.1-0.4 | 0.1-0.4 | 0.2-0.5 |
| | (mm) | | | | | | | |
| | Radius of | 0.2-0.4 | 0.3-0.5 | 0.3-0.6 | 0.3-1.0 | 0.3-1.0 | 0.4-1.2 | 0.5-1.5 |
| | Curvature of | | | | | | | |
| | Waves r | | | | | | | |
| Large Wavy | Pitch P₂ (mm) | 2.0-3.0 | 2.0-4.0 | 2.0-5.0 | 3.0-6.0 | 4.0-7.0 | 5.0-8.0 | 6.0-10.0 |
| Edge | Wave Width W₂ | 0.1-0.3 | 0.1-0.4 | 0.1-0.6 | 0.2-0.8 | 0.3-1.0 | 0.4-1.0 | 0.5-1.2 |
| | (mm) | | | | | | | |
| | Radius of | 2.0-4.0 | 3.0-5.0 | 3.0-5.0 | 3.0-5.0 | 4.0-6.0 | 4.0-6.0 | 4.0-6.0 |
| | Curvature of | | | | | | | |
| | Waves R (mm) | | | | | | | |

As described above, since the cutting edge 12 is formed to be a composite wave pattern constituted by the small wave pattern 12a with a small pitch P₁ and the large wave pattern 12b with a large pitch P₂, the composite wave pattern is provided with a plurality of wave crests in the small wave pattern 12a in the longitudinal direction per single wave in the large wave pattern 12b. In other words, each wave of the large wave pattern contains a plurality of waves of the small wave pattern.

Herein used, “each wave” of the large wave pattern 12b refers to any continuous portion of the large wave pattern 12b on either side of the widthwise centerline CL of the blade plate 10 (see FIG. 2E) (reference line).

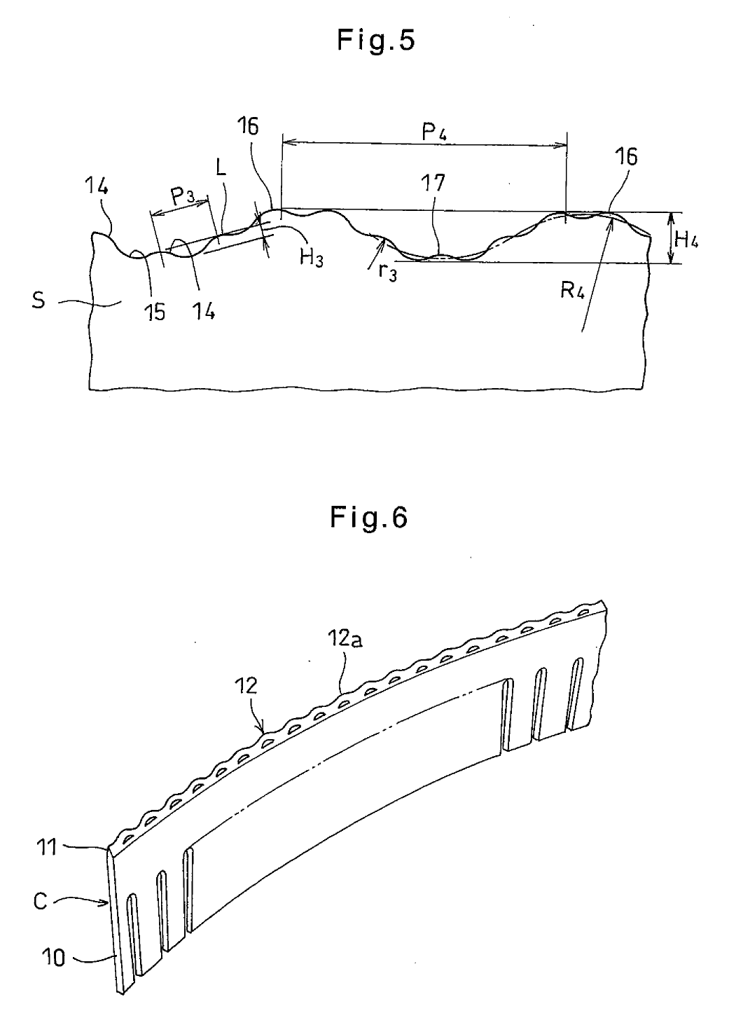

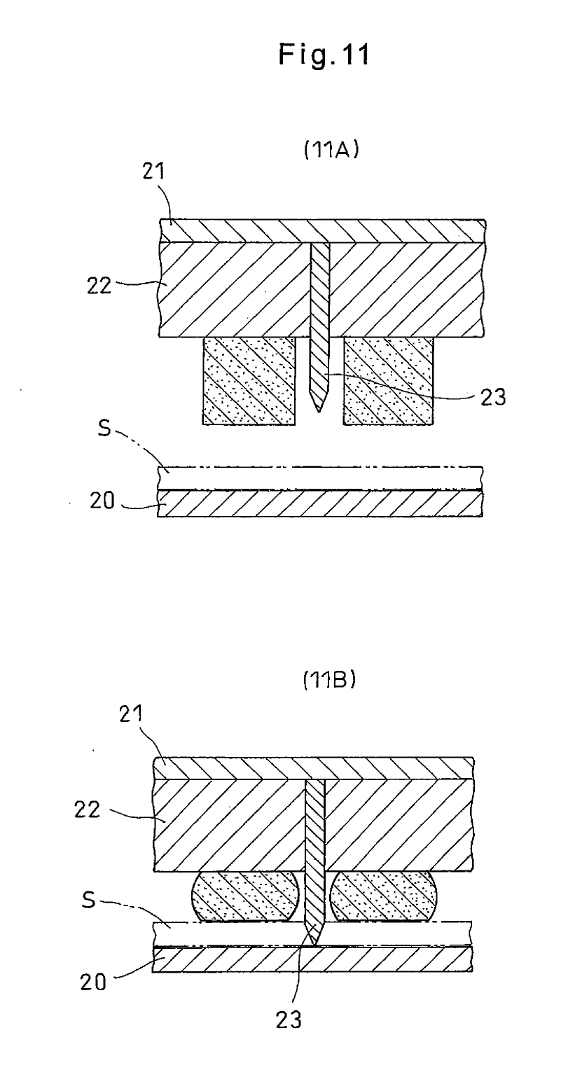

The die-cutting blade according to the embodiment has the aforementioned structure. By mounting this die-cutting blade in a cutting die 22 illustrated in FIG. 11 and by performing, therewith, die cutting on a sheet S supported on a cutting plate 20, as illustrated in FIG. 5, it is possible to form, in the sheet S, a die-cut line L formed from a composite wavy line corresponding to the shape of the composite wave pattern constituted by the small wave pattern 12a and the large wave pattern 12b illustrated in FIG. 2E.

Further, since the blade plate 10 is maintained at a straight-shaped strip-plate state at its portion other than the edge portion, it is easy to perform processing for forming, in the cutting die 22, a mounting slot for inserting and mounting the blade plate 10 therein and, further, it is easy to mount the blade plate 10 therein.

The cut line L is a composite wavy line constituted by a small wavy curve having a shape with a small undulation forming alternate and successive crests 14 and troughs 15 corresponding to the shapes of the wave crests in the alternately opposite directions in the small wave pattern 12a, and a large wavy curve having a shape with a large undulation forming alternate and successive crests 16 and troughs 17 corresponding to the shapes of the wave crests in the alternately opposite directions in the large wave pattern 12b. In a preferable example, the pitch P₃ of the crests 14 in the small wavy curve falls within the range of 0.2 mm to 2.0 mm, and the pitch of the troughs 15 is equal thereto. Further, the height H₃ of the crests 14 (corresponding to the wave width W₁ of the small wavy edge 12a) falls within the range of 0.02 mm to 0.5 mm, and the depth of the troughs 15 is equal thereto. Further, the radius of curvature r₃ of the crests 14 (corresponding to the radius of curvature r of the waves in the small wave pattern 2a) falls within the range of 0.2 mm to 1.5 mm, and the radius of curvature of the troughs 15 is equal thereto. On the other hand, in a preferable example, the pitch P₄ of the crests 16 in the large wavy curve falls within the range of 2.0 mm to 10.0 mm, and the pitch of the troughs 17 is equal thereto. Further, the height H₄ of the crests 16 (corresponding to the wave width W₂ of the large wavy edge 12b) falls within the range of 0.1 mm to 1.2 mm, and the depth of the troughs 17 is equal thereto. Further, the radius of curvature R₄ of the crests 16 (corresponding to the radius of curvature R of the waves) falls within the range of 2.0 mm to 6.0 mm, and the radius of curvature of the troughs 17 is equal thereto. Accordingly, the cut line L comes into contact with the hands extremely smoothly and, therefore, will not injure the hands, even if it is touched by the hands. Further, the cutting edge 12 has the same shapes as those of the small wavy curve and the large wavy curve which have been described above.

Further, the cutting edge 12 for use in die cutting for sheets S is formed to be the composite wave pattern constituted by the small wave pattern 12a, and the large wave pattern 12b formed by bending the small wave pattern 12a into a wave shape over its entire length in the longitudinal direction. Accordingly, during die cutting for sheets S, it is possible to suppress formation of stripe-type elongated paper dusts, particularly, from corrugated medium paper which is formed in corrugated shapes in corrugated paperboard sheets.

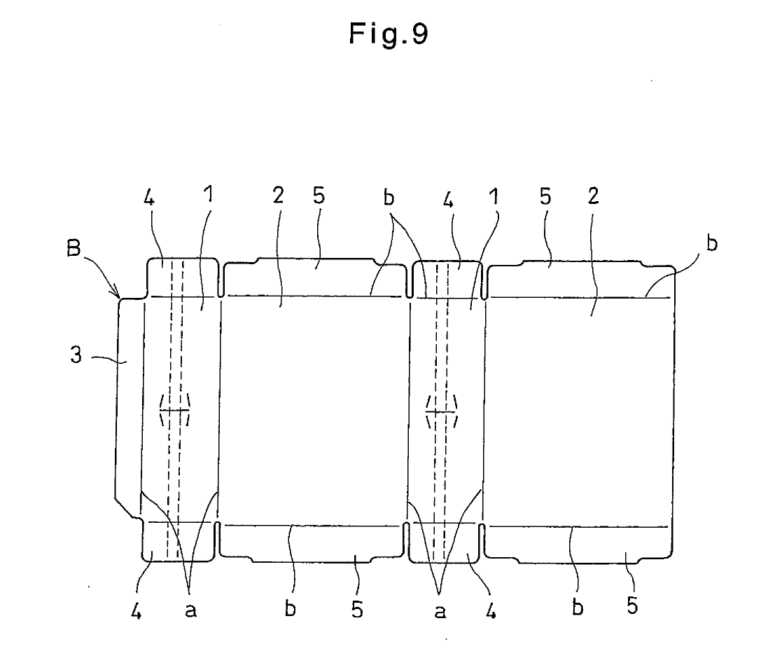

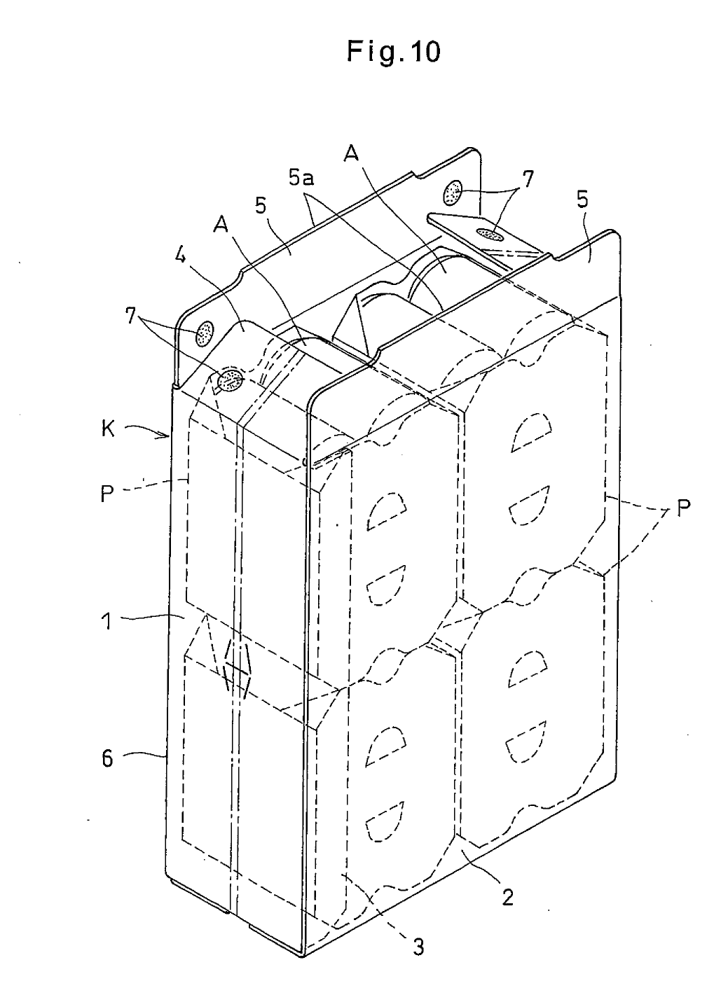

In this case, in die cutting for a blank to form a wrap around case as illustrated in FIG. 9, its entire outer peripheral edges which form the outline can be formed from cut lines L formed from a composite wavy line constituted by a small wavy curve and a large wavy curve, or only the outer peripheral edges of the outer flaps thereof can be formed from cut lines L formed from a composite wavy line constituted by a small wavy curve and a large wavy curve.

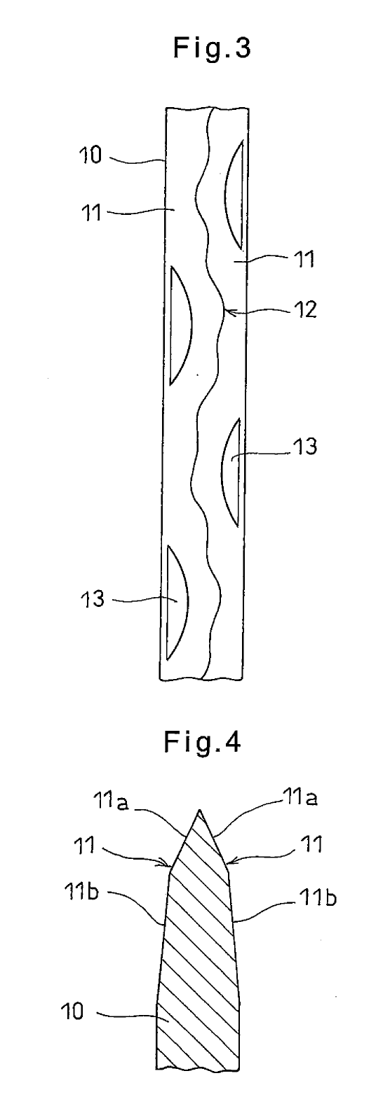

In the embodiment illustrated in FIG. 1 and FIGS. 2C and 2E, the cutting edge 12 is formed from the small wave pattern 12a and the large wave pattern 12b which have respective regular sine-wave shapes having fixed pitches P₁ and P₂, fixed wave widths W₁ and W₂, and fixed radii of curvature r and R of the waves therein. However, as illustrated in FIG. 3, the small wave pattern 12a and the large wave pattern 12b can have respective wave shapes with irregular pitches and irregular wave widths, provided that the cutting edge 12 is formed to be a composite wave pattern constituted by the small wave pattern 12a which is bent to have an undulation forming an arrangement of a plurality of wave-crests in alternately opposite directions toward the opposite side surfaces of the blade plate 10 in the longitudinal direction within the range of the thickness of the blade plate 10, and the large wave pattern 12b which is bent to have an undulation forming an arrangement of a plurality of wave crests in alternately opposite directions toward the opposite side surfaces of the blade plate in the longitudinal direction within the range of the thickness of the blade plate 10. Alternatively, although not illustrated in the figures, either one of the small wave pattern 12a and the large wave pattern 12b may be formed to have a wave shape with a regular pitch and a regular wave width, while the other one of them may be formed to have a wave shape with an irregular pitch and an irregular wave width. In any of the cases, the large wave pattern 12b can be formed by using the entire small wave pattern 12a as a reference, in order to form a composite wave pattern. However, the pitch in the small wave pattern 12a should be smaller than the pitch in the large wave pattern 12b such that each wave of the large wave pattern 12b contains a plurality of continuous ones of the waves of the small wave pattern 12a.

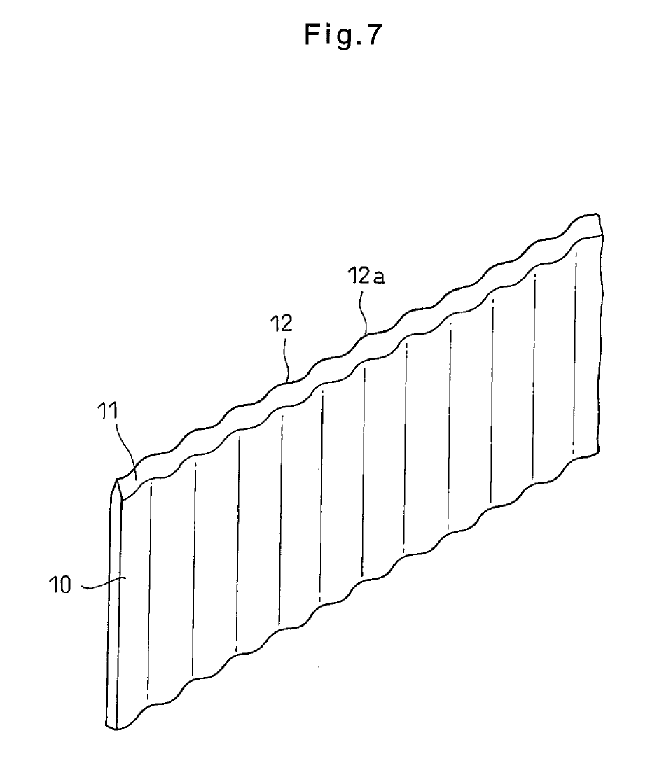

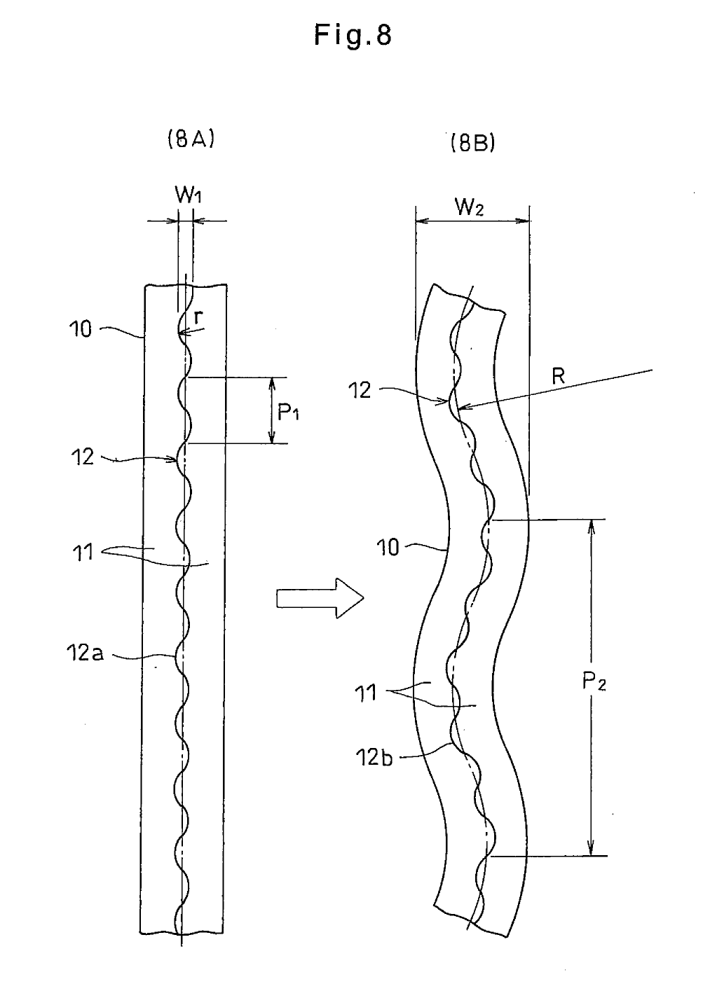

Further, in the embodiment illustrated in FIG. 1 and FIGS. 2C and 2E, both the small wave pattern 12a and the large wave pattern 12b are made to have undulations within the range of the thickness T of the blade plate 10. However, as illustrated in FIG. 7 and FIGS. 8A and 8B, the blade plate 10 itself can be made to have a large undulation in the longitudinal direction thereof in such a way as to form crests and troughs in the heightwise direction over the entire opposite side surfaces of the blade plate 10 to form the large wave pattern 12b, while only the small wave pattern 12a is made to form a wave crests and troughs in the heightwise direction within the range of the thickness of the blade plate 10 to have a small undulation therein, in order to provide a plurality of waves in the small wave pattern 12a per single wave in the large wave pattern 12b.

Namely, as illustrated in FIG. 8A, the small wave pattern 12a can be formed at the portion of the intersection of the pair of chamfers 11 formed in the blade plate 10 within the range of the thickness T of the blade plate 10 and, as illustrated in FIG. 8B, press forming can be performed on the entire blade plate 10 over its entire length for shaping the blade plate 10 into a wave shape.

Further, in the embodiment illustrated in FIGS. 7 and 8, the large wave pattern 12b can be formed by undulating the entire blade plate 10 in the longitudinal direction thereof, which makes the fabrication of the large wave pattern 12b easier than in case of undulating only a portion of the blade plate 10 for forming it. The blade plate 10 also has a wave shape at its portion to be mounted in the cutting die 22, which enables mounting the blade plate 10 in the cutting die 22 in a firmly secured state.

Further, as the blade plate 10, there has been exemplified one having two chamfers 11 formed on the respective opposite side surfaces so as to extend from the cutting edge. However, the chamfers 11 are not limited thereto. For example, as illustrated in FIG. 4, two inclined surfaces 11a and 11b having different inclination angles can be continuously formed therein in order from the blade tip.

While, in the embodiment, there has been exemplified die cutting for a blank B to form a wrap around case K which is made of a corrugated paperboard sheet, the case-forming material and the case are not limited thereto. For example, it is also possible to employ package boxes made of a paperboard.

Further, while, in the embodiment, there has been exemplified a die-cutting blade to be mounted in a cutting die in a flat die cutting machine, the die-cutting blade is not limited to one of a flat type. For example, as illustrated in FIG. 6, the die-cutting blade can be an arc-shaped die-cutting blade C to be mounted in an arc-shaped cutting die in a rotary die cutting machine.

### DESCRIPTION OF THE REFERENCE NUMERALS

10 Blade plate
11 Chamfer
12 Cutting edge
12a Small wave pattern
12b Large wave pattern

1. A sheet die-cutting blade comprising a strip-plate-shaped blade plate having a predetermined length and made of a steel plate, the blade plate being provided with a pair of chamfers formed on the respective side surfaces of the blade plate so as to extend from one side edge of the blade plate at substantially the same inclination angle, the chamfers defining a cutting edge along the one side edge of the blade plate,
characterized in that the cutting edge has a composite wave pattern comprising a large wave pattern and a small wave pattern, the large wave pattern comprising a plurality of longitudinally continuous large waves, the small wave pattern comprising a plurality of longitudinally continuous small waves, wherein each of the large waves contains a plurality of the small waves, and wherein the small wave pattern is entirely located within the thickness of the blade plate.

2. The sheet die-cutting blade of claim 1, wherein the large wave pattern is located within the thickness of the blade plate, and wherein only the chamfers have a wave pattern having crests and troughs corresponding to the large wave pattern.

3. The sheet die-cutting blade of claim 1, wherein the entire opposite side surfaces of the blade plate have a wave pattern having crests and troughs corresponding to the large wave pattern.

4. The sheet die-cutting blade of claim 1, wherein the large wave pattern and small wave pattern have respective sine-curve wave shapes having fixed pitches, fixed wave widths, and fixed radii of curvature of their respective waves, and the pitch P₂, the wave width W₂, and the radius of curvature R of the waves in the large wave pattern fall within ranges of: P₂=2.0 mm to 10.0 mm, W₂=0.1 mm to 1.2 mm, and R=2.0 mm to 6.0 mm.

5. The sheet die-cutting blade of claim 4, wherein when the thickness of the blade plate is about 0.7 mm, the pitch P₂, the wave width W₂, and the radius of curvature R of the waves in the large wavy edge fall within ranges of: P₂=2.0 mm to 4.0 mm, W₂=0.1 mm to 0.4 mm, and R=3.0 mm to 5.0 mm, and the pitch P₁, the wave width W₁, and the radius of curvature r of the waves in the small wave pattern fall within ranges of: P₁=0.4 mm to 0.8 mm, W₁=0.04 mm to 0.1 mm, and r=0.3 mm to 0.5 mm.

6. The sheet die-cutting blade of claim 4, wherein when the thickness of the blade plate is about 0.9 mm, the pitch P₂, the wave width W₂ and the radius of curvature R of the waves in the large wave pattern fall within ranges of: P₂=2.0 mm to 5.0 mm, W₂=0.1 mm to 0.6 mm, and R=3.0 mm to 5.0 mm, and the pitch P₁, the wave width W₁, and the radius of curvature r of the waves in the small wave pattern fall within ranges of: P₁=0.6 mm to 1.2 mm, W₁=0.05 mm to 0.2 mm, and r=0.3 mm to 0.6 mm.

7. The sheet die-cutting blade of claim 4, wherein when the thickness of the blade plate is about 1.07 mm, the pitch P₂, the wave width W₂, and the radius of curvature R of the waves in the large wave pattern fall within ranges of: P₂=3.0 mm to 6.0 mm, W₂=0.2 mm to 0.8 mm, and R=3.0 mm to 5.0 mm, and the pitch P₁, the wave width W₁, and the radius of curvature r of the waves in the small wave pattern fall within ranges of: P₁=0.8 mm to 1.4 mm, W₁=0.08 mm to 0.3 mm, and r=0.3 mm to 1.0 mm.

8. The sheet die-cutting blade of claim 1, wherein the large wave pattern and the small wave pattern have respective curved shapes having irregular pitches and irregular wave widths in the longitudinal direction of the blade plate.

9. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 1, to and the cut line is formed from a composite wavy line formed from a small wavy curve having a small undulation forming alternate and successive crests and troughs, and a large wavy curve having a large undulation forming alternate and successive crests and troughs.

10. The die-cut blank of claim 9, wherein the small wavy curve and the large wavy curve of the composite wavy line include respective sine-wave curves and are adapted to satisfy: P₃=0.2 mm to 2.0 mm, H₃=0.02 mm to 0.5 mm, r₃=0.2 mm to 1.5 mm, and P₄=2 mm to 10.0 mm, H₄=0.1 mm to 1.2 mm, and R₄=2.0 mm to 6.0 mm,
assuming that the pitch of the crests is P₃, the height of the crests is H₃, and the radius of curvature of the waves is r₃ in the small wavy curve, and the pitch of the crests is P₄, the height of the crests is H₄, and the radius of curvature of the waves is R₄ in the large wavy curve.

11. A sheet die-cutting blade comprising a strip-plate-shaped blade plate having a predetermined length and made of a steel plate, the blade plate being provided with a pair of chamfers formed on the respective side surfaces of the blade plate so as to extend from one side edge of the blade plate at substantially the same inclination angle, the chamfers defining a cutting edge along the one side edge of the blade plate,
characterized in that the cutting edge has a curved shape identical to the composite wavy line according to claim 10.

12. The sheet die-cutting blade of claim 2, wherein the large wave pattern and small wave pattern have respective sine-curve wave shapes having fixed pitches, fixed wave widths, and fixed radii of curvature of their respective waves, and the pitch P₂, the wave width W₂, and the radius of curvature R of the waves in the large wave pattern fall within ranges of: P₂=2.0 mm to 10.0 mm, W₂=0.1 mm to 1.2 mm, and R=2.0 mm to 6.0 mm.

13. The sheet die-cutting blade of claim 3, wherein the large wave pattern and small wave pattern have respective sine-curve wave shapes having fixed pitches, fixed wave widths, and fixed radii of curvature of their respective waves, and the pitch P₂, the wave width W₂, and the radius of curvature R of the waves in the large wave pattern fall within ranges of: P₂=2.0 mm to 10.0 mm, W₂=0.1 mm to 1.2 mm, and R=2.0 mm to 6.0 mm.

14. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 2, and the cut line is formed from a composite wavy line formed from a small wavy curve having a small undulation forming alternate and successive crests and troughs, and a large wavy curve having a large undulation forming alternate and successive crests and troughs.

15. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 3, and the cut line is formed from a composite wavy line formed from a small wavy curve having a small undulation forming alternate and successive crests and troughs, and a large wavy curve having a large undulation forming alternate and successive crests and troughs.

16. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 4, and the cut line is formed from a composite wavy line formed from a small wavy curve having a small undulation forming alternate and successive crests and troughs, and a large wavy curve having a large undulation forming alternate and successive crests and troughs.

17. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 5, and the cut line is formed from a composite wavy line formed from a small wavy curve having a small undulation forming alternate and successive crests and troughs, and a large wavy curve having a large undulation forming alternate and successive crests and troughs.

18. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 6, and the cut line is formed from a composite wavy line formed from a small wavy curve having a small undulation forming alternate and successive crests and troughs, and a large wavy curve having a large undulation forming alternate and successive crests and troughs.

19. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 7, and the cut line is formed from a composite wavy line formed from a small wavy curve having a small undulation forming alternate and successive crests and troughs, and a large wavy curve having a large undulation forming alternate and successive crests and troughs.

20. A case-forming die-cut blank comprising:
two pairs of opposing side panels to form a rectangular tubular-shaped body;
inner flaps provided continuously on respective end edges of one pair of side panels; and
outer flaps provided continuously on respective end edges of the remaining pair of side panels, such that the outer flaps are to be adhered to the inner flaps to close an opening of the body,
characterized in that the blank has outer peripheral edges, of which at least outer peripheral edges of the outer flaps are formed from a cut line formed by die cutting with the sheet die-cutting blade according to claim 8, and the cut line is formed from a composite wavy line formed from a small wavy curve having a small undulation forming alternate and successive crests and troughs, and a large wavy curve having a large undulation forming alternate and successive crests and troughs.
